(19) United States
(12) Patent Application Publication
(10) Pub. No.: US 2019/0317662 A1
(43) Pub. Date: Oct. 17, 2019

(54) INFORMATION PROVIDING METHOD AND ELECTRONIC DEVICE SUPPORTING SAME

(71) Applicant: SAMSUNG ELECTRONICS CO., LTD., Suwon-si, Gyeonggi-do (KR)

(72) Inventors: Hyung Rae CHO, Seoul (KR); Gi Ppeum CHOI, Suwon-si, Gyeonggi-do (KR); Jin RA, Suwon-si, Gyeonggi-do (KR); Seung Eok CHOI, Suwon-si, Gyeonggi-do (KR)

(21) Appl. No.: 16/467,162

(22) PCT Filed: Dec. 8, 2017
(86) PCT No.: PCT/KR2017/014389

§ 371 Date: Jun. 6, 2019

(30) Foreign Application Priority Data
Dec. 9, 2016 (KR) 10-2016-0167848

(51) Int. Cl. G06F 3/0484; G05B 19/042

(52) U.S. Cl. CPC G06F 3/04847; G05B 2219/25011; G05B 19/042

(57) ABSTRACT

An embodiment of the disclosure discloses an electronic device to interact with an external device operating an automatic building control system, which includes a communication module to make communication with the external device, a memory to store an application program associated with the automatic building control system, a display to output an execution screen of the application program, and processor electrically connected with the communication module, the memory, and the display. The processor is configured to output at least one user interface to input specified information associated with updating a schedule of the automatic building control system or to input information on a response to a notification, which is transmitted from the external device, associated with the operation of the automatic building control system, when the application is executed, and to transmit the information, which is input into the at least one user interface, to the external device. Moreover, various embodiment found through the disclosure are possible.

### TECHNICAL FIELD

Various embodiments disclosed in the disclosure relate to scheduling technologies of an automatic building control system.

### BACKGROUND ART

As various industrial fields are rapidly developed, buildings have been enlarged or high-rise buildings have been increased in a modern society. In addition, high-performance electronic devices or cutting-edge IT technologies are concentrated in a building, and the building serves as a platform contributing to the development of a ubiquitous society beyond a simple residential or work space. Further buildings in the modern society help the construction of an intelligent communication infrastructure between electronic devices and people by employing an Internet Of Things (IoT) system

However, although the buildings are advanced, the buildings have problems with the increase in energy consumption. This is linked to the national economy problem. Accordingly, alternatives have been suggested to manage the efficient energy management of the buildings, and an automatic building control system is spotlighted by way of example.

### DISCLOSURE

### Technical Problem

A conventional automatic building control system processes automation control such as heating/cooling control, humidity control, or lighting control depending on a specified schedule without variation. Therefore, there may be a limitation in managing a comfortable degree in a building based on the density of occupants, and various needs of the occupants, environmental causes, or variables may not be reflected instantly in the building.

Various embodiments disclosed in the disclosure may provide a method for providing information and an electronic device for supporting the same, capable of supporting the optimized automatic building control system by sharing various pieces of information associated with the building management with a control device of the automatic building control system in real time.

### Technical Solution

According to an embodiment, an electronic device to interact with an external device operating an automatic building control system may include a communication module to make communication with the external device, a memory to store an application program associated with the automatic building control system, a display to output an execution screen of the application program, and a processor electrically connected with the communication module, the memory, and the display.

According to an embodiment, the processor may output at least one user interface to input specified information associated with updating a schedule of the automatic building control system or to input information on a response to a notification, which is transmitted from the external device, associated with the operation of the automatic building control system, when the application is executed, and may transmit the information, which is input into the at least one user interface, to the external device.

### Advantageous Effects

According to various embodiments, the interaction platform with the automatic building control system may be instantly constructed based on the electronic device.

According to various embodiments, preset operation schedules for the automatic building control system may be changed or updated based on at least one piece of building operation information, thereby operating the automatic building control system.

Besides, a variety of effects directly or indirectly understood through the disclosure may be provided.

### DESCRIPTION OF DRAWINGS

FIG. 1 is a view illustrating an automatic building control system, according to an embodiment;

FIG. 2 is a view illustrating the configuration of the first electronic device, according to an embodiment;

FIG. 3 is a view illustrating the form of a first user interface output by the first electronic device, according to an embodiment;

FIG. 4 is a view illustrating various forms of a second user interface output by the first electronic device, according to an embodiment;

FIG. 5 is a view illustrating various forms of a third user interface output by the first electronic device, according to an embodiment;

FIG. 6 is a view illustrating various forms of a fourth user interface output by the first electronic device, according to an embodiment;

FIG. 7 is a view illustrating a method of providing information by the first electronic device, according to an embodiment;

FIG. 8A illustrates collection form of the information by the third electronic device, according to an embodiment;

FIG. 8B is a view illustrating the form of an information table formed by the third electronic device, according to an embodiment;

FIG. 8C illustrates the collection form of second information by the third electronic device, according to an embodiment;

FIG. 8D is a view illustrating the temperature control of the third electronic device, according to an embodiment;

FIG. 8E is a view illustrating the form of index information formed in the third electronic device, according to an embodiment;

FIG. 8F is a view illustrating the control of a specific zone inside a building by the third electronic device, according to an embodiment;

FIG. 9 is a view illustrating another example of the control for a specific zone inside the building by the third electronic device, according to an embodiment;

FIG. 10 is a flowchart illustrating the operation of the automatic building control system based on the request information of the third electronic device, according to an embodiment;

FIG. 11 is a diagram illustrating an electronic device in a network environment, according to an embodiment;

FIG. 12 is a block diagram of the electronic device, according to an embodiment; and

FIG. 13 is a block diagram of a program module, according to an embodiment.

In the following description made with respect to the accompanying drawings, similar components will be assigned with similar reference numerals.

### MODE FOR INVENTION

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents. With respect to the descriptions of the accompanying drawings, like reference numerals refer to like elements.

The term “include,” “comprise,” and “have”, or “may include,” or “may comprise” and “may have” used herein indicates disclosed functions, operations, or existence of elements but does not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms such as “1st,” “2nd,” “first,” “second,” and the like used herein may refer to modifying various different elements of various embodiments of the present disclosure, but are not intended to limit the elements. For instance, “a first user device” and “a second user device” may indicate different user devices regardless of order or importance. For example, a first component may be referred to as a second component and vice versa without departing from the scope of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed” another component (for example, a second component), another component (for example, a third component) does not exist between the component (for example, the first component) and the other component (for example, the second component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in various embodiments of the present disclosure are used to describe certain embodiments of the present disclosure, but are not intended to limit the scope of other embodiments. The terms of a singular form may include plural forms unless they have a clearly different meaning in the context. Otherwise, all terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. In any case, even the terms defined in the present specification are not intended to be interpreted as excluding embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit).

In some various embodiments of the present disclosure, an electronic device may be a home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ or PlayStation™), an electronic dictionary, an electronic key, a camcorder, or an electronic picture frame.

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA) device, a magnetic resonance imaging (MRI) device, a computed tomography (CT) device, a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of new technology.

Hereinafter, an electronic device according to various embodiments of the present disclosure will be described in more detail with reference to the accompanying drawings. The term “user” used herein may refer to a person who uses an electronic device or may refer to a device (e.g., an artificial intelligence electronic device) that uses an electronic device.

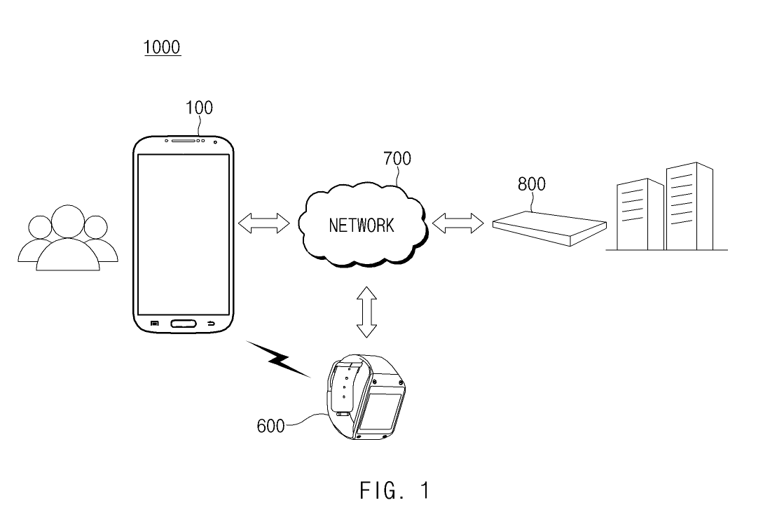

FIG. 1 is a view illustrating an automatic building control system, according to an embodiment.

Referring to FIG. 1, an automatic building control system 1000 may include a first electronic device 100 (e.g., a mobile device), a second electronic device 600 (e.g., a wearable device), a network 700, and a third electronic device 800 (e.g., a control device of the automatic building control system 1000).

In an embodiment, the first electronic device 100 and/or the second electronic device 600 may interact with the third electronic device 800 by constructing the network 700. For example, the first electronic device 100 and/or the second electronic device 600 may transmit at least one piece of first information, which is associated with the operation of the automatic building control system 1000, to the third electronic device 800 by making wired or wireless communication based on the network 700. The third electronic device 800 may receive and process the first information and may transmit at least one piece of second information to the first electronic device 100 and/or the second electronic device 600 in response to this.

In association with the transmission and/or the reception of the above-described information, the first electronic device 100 may include an application program systematically linked to the automatic building control system 1000. The first electronic device 100 may output at least one user interface when the application program is executed, and may transmit at least one piece of first information, which is input onto the user interface from a user, to the third electronic device 800. In an embodiment, the first information may include visit reservation information of a user for a specified building, the feedback information or request information of the user, which is associated with the operation of the automatic building control system 1000, or information on a response to the second information received from the third electronic device 800.

In an embodiment, the second electronic device 600 may transmit, as the first information, health information of the user to the third electronic device 800 in response to user control or specified scheduling information. For example, the second electronic device 600 may download (or stream) health history information of the user from a specified external server and may transmit the health history information to the third electronic device 800. In addition, the second electronic device 600 may transmit the health information of the user to the first electronic device 100 and request the first electronic device 100 to forward the health information of the user to the third electronic device 800. Alternatively, the second electronic device 600 may transmit body temperature information of the user, which is measured by an internal sensor (e.g., temperature sensor) in real time or at a specified period, to the third electronic device 800. In an embodiment, the health history information or the body temperature information of the user, which is transmitted from the second electronic device 600 to the third electronic device 800, may be considered when calculating the reliability of another first information (e.g., feedback information of the user, which is associated with the operation of the automatic building control system) or the operation of the automatic building control system 1000, which is focused on a specific user.

According to an embodiment, the third electronic device 800 may change or update the schedule for the operation of the automatic building control system 1000, based on at least one first information received from the first electronic device 100 and/or the second electronic device 600. For example, the third electronic device 800 may change or update a preset automatic control schedule, which is associated with cooling/heating control or humidity control inside a building or control of facilities inside the building, to correspond to the first information (or to reflect the first information). In an embodiment, the third electronic device 800 may transmit, to the first electronic device 100 and/or the second electronic device 600, second information (e.g., notification information associated with the change or the update of the schedule), when the change or the update of the automatic control schedule is completed based on the first information.

Hereinafter, the execution of the function of each electronic device and various operation examples of the automatic building control system 1000 based on the execution of the function will be described in association with the change or the update of the schedule of the automatic building control system 1000.

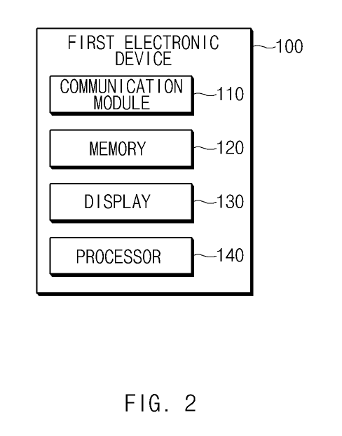

FIG. 2 is a view illustrating the configuration of the first electronic device, according to an embodiment.

Referring to FIG. 2, the first electronic device 100 may include a communication module 110, a memory 120, a display 130, and a processor 140.

In various embodiments, the first electronic device 100 may not include at least one of the above-described components or may further include other component(s) For example, the first electronic device 100 may further include an input/output interface (e.g., a USB connector) to support the transmission/reception of data or a signal to/from an external device, a power supply device (e.g., a battery) to supply driving power to the components, or a sensor module (e.g., a proximity sensor, an acceleration sensor, a fingerprint recognition sensor, or an iris sensor) to sense various pieces of information on an operation environment of the first electronic device 100.

The communication module 110 may establish wired communication or wireless communication with at least one external device (e.g., the second electronic device 600 (see FIG. 1) and/or the third electronic device 800 (see FIG. 1)) based on a specified protocol and make the wired communication or the wireless communication to access a network 700 (see FIG. 1). The communication module 110 may transmit or receive at least one information, which is associated with the operation of the automatic building control system 1000 (see FIG. 1), with at least one external device (e.g., the second electronic device 600 and/or the third electronic device 800), based on the access to the network 700.

The memory 120 may store at least one piece of data associated with the operation of the first electronic device 100 or the automatic building control system 1000 or may store at least one instruction associated with the functional operation of the first electronic device 100. In addition, the memory 120 may store at least one application program associated with the operation of the automatic building control system 1000. In an embodiment, the memory 120 may store at least one piece of information (e.g., first information) input from a user when the application program is executed, and may load stored information under the control of the processor 140.

The display 130 may output various screens associated with the operation of the first electronic device 100. For example, the display 130 may output an execution screen of an application program associated with the automatic building control system 1000 in response to user control. In an embodiment, the display 130 may output at least one user interface that constitutes at least a portion of an execution screen when the application program is executed. The display 130 may provide a specified display effect onto the user interface or may output another user interface having a switching relationship, in response to the user input (e.g., the touch) applied to at least one area of the user interface.

The processor 140 is electrically or operatively connected with other components of the electronic device 100 to perform a control, a communication computation, or data processing for the components. For example, the processor 140 may control the display 130 to execute a specified application program or to output at least one user interface in response to receiving information (e.g., the second information) from an external device (e.g., the third electronic device 800). Alternatively the processor 140 may control at least one of the communication module 110 or the memory 120 to transmit at least one piece of information associated with the user input to the external device (e.g., the third electronic device 800), when the user input (e.g., a touch) is applied to a specified area on the user interface.

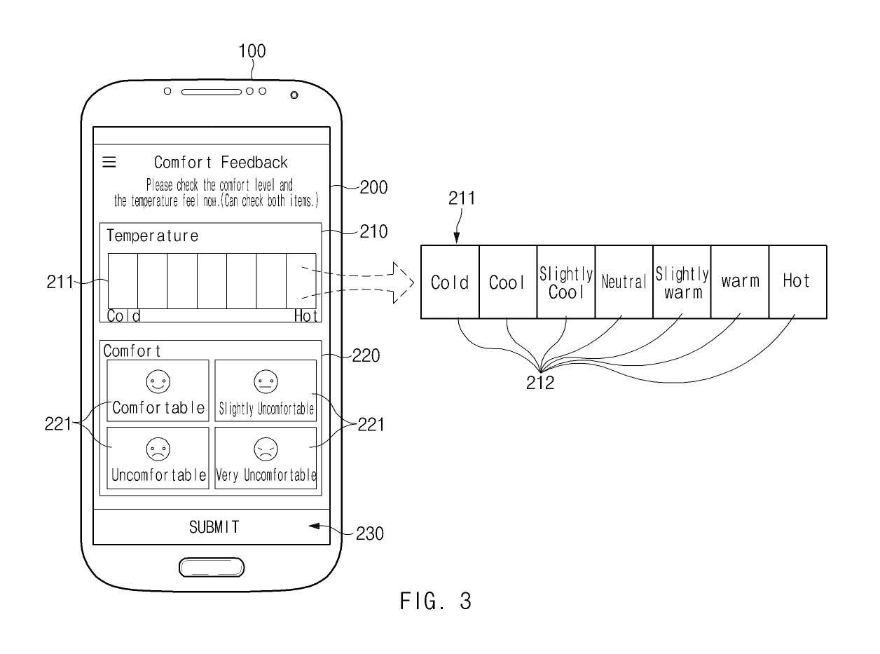

Hereinafter, at least one user interface described with reference to FIGS. 3 to 6 may be output with mutually different screens (see FIG. 1) corresponding to the manipulation of a specified menu by a user, on the execution screen of the application program (hereinafter, referred to as the first application) associated with the automatic building control system 1000.

FIG. 3 is a view illustrating the form of the first user interface output by the first electronic device, according to an embodiment.

In an embodiment, a user of the first electronic device 100 may be positioned in a specific zone inside a specified building. The user may transmit specified feedback information to an external device (e.g., the third electronic device 800 (see FIG. 1)), which controls the automatic building control system, in association with the control of a current temperature and/or humidity of the specific zone. In this connection, the processor 140 (see FIG. 2) of the first electronic device 100 may output the first user interface to support the input of the feedback information, when the first application is executed under the user control. Referring to FIG. 3, the processor 140 may include, onto a first user interface 200, for example, a first area 210 to input information on a temperature desired by a user, a second area 220 to input emotion information of the user, or a third area 230 associated with transmitting the input information.

According to an embodiment, the first area 210 may include a first object 211 (e.g., a color spectrum) to represent a high or low of the temperature in the form of visual information (e.g., color). According to an embodiment, the first object 211 may include a plurality of visual areas 212 split based on a specified temperature range. The processor 140 may provide indexes (e.g., “Cold”, “Cool”, “Slightly cool”, “Natural”, “Slightly warm”, “Warm”, or “Hot”), which are referred to as a temperature degrees for the plurality of visual areas 212, for example, relevant visual areas. According to an embodiment, when a user input (e.g., a touch) is applied onto the first object 211, a specified bar may be displayed and the user may set the desired temperature by manipulating the bar. When the bar is manipulated toward a first direction (e.g., a temperature-up direction) or a second direction (e.g., temperature-down direction), content (e.g., a number) based on a temperature corresponding to the position of the bar may be displayed on at least one area of the first object 211.

According to an embodiment, the second area 220 may include at least one second object 221 (e.g., an emoticon) serving as an index of a comfortable degree or an uncomfortable degree. When the user input (e.g., touch) is applied to any one of the at least one second object 221, the second object or a specified area including the second object may be processed with a specified display effect (e.g., color variation or the variation in an outline of the area).

In an embodiment, the first area 210 and the second area 220 may be compatibly used. For example, the user may input information by selecting both temperature information and emotion temperature included in the first area 210 and the second area 220 or by selecting only information (e.g., temperature information or emotion temperature) included in any one of the first area 210 or the second area 220.

In an embodiment, the third area 230 may perform a function associated with the transmission of information input to the first area 210 and/or the second area 220. For example, when a user input (e.g., a touch) is applied to at least a portion of the third area 230, the processor 140 may transmit information input to the first area 210 and/or the second area 220 to the external device (e.g., the third electronic device 800). In an embodiment, the processor 140 may output a vibration or sound having a specified pattern, in response to the user input applied to the at least a portion of the third area 230.

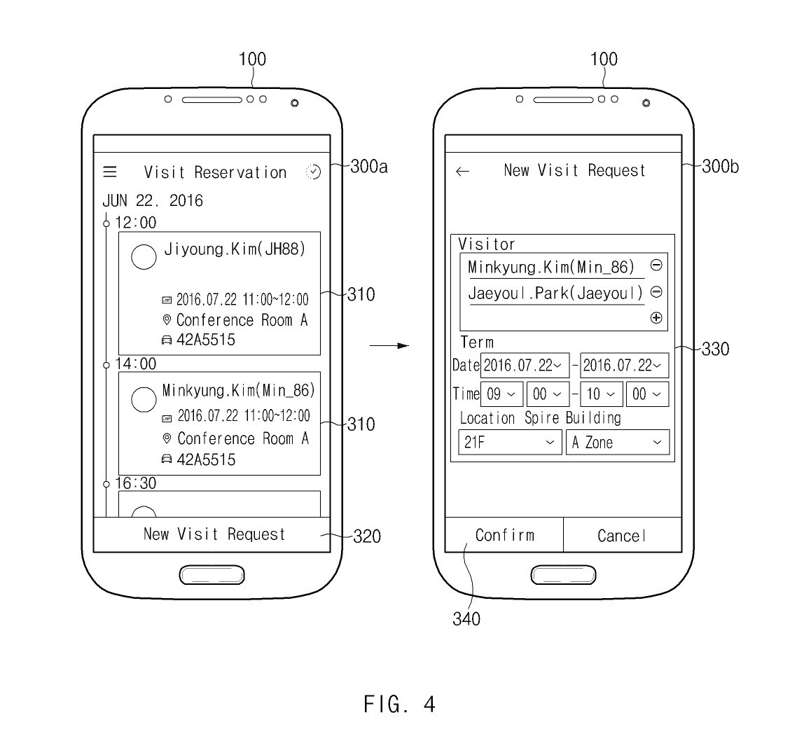

FIG. 4 is a view illustrating various forms of a second user interface output by the first electronic device, according to an embodiment.

In an embodiment, a user of the first electronic device 100 may make a reservation for visiting the above-described building based on the execution of the first application. In this connection, the processor 140 (see FIG. 2) of the first electronic device 100 may output a second user interface to support the input of at least one piece of information associated with the visit reservation, when executing the first application. Referring to FIG. 4, the processor 140 may include, onto the second user interface 300a, at least one first area 310 to display visit reservation information, which is previously input, by other users or a second area 320 associated with the request for a new visit reservation.

In an embodiment, the first area 310 may include schematic information associated with a visit reservation of a specific user. For example, the first area 310 may include at least one of applicant information (e.g., a profile image or name) for a visit reservation, date information (e.g., a date or time), or spatial information (e.g., a room number of a guest number or a conference number). In an embodiment, the at least one first area 310 may be arranged in the form of a list on the second user interface 300a based on the date information.

According to an embodiment, the second area 320 may perform a function associated with the request for the new visit reservation. When a user input (e.g., a touch) is applied to at least a portion of the second area 320, the processor 140 may change a second user interface 300a to a second user interface 300b having a different configuration. For example, the processor 140 may change the second user interface 300a including at least one of the first area 310 or the second area 320 to the second user interface 300b including at least one of a third area 330 to input the information on the new visit reservation or a fourth area 340 associated with the transmission of the information on the new visit reservation. The processor 140 may transmit the visit reservation information input into the third area 330 to an external device (e.g., the third electronic device 800 (see FIG. 1), in response to the user input (e.g., the touch) applied to at least a portion (e.g., a confirm area) of the fourth area 340. The external device (e.g., the third electronic device 800) may update a specific date, time, the number of visitors, or the schedule for cooling/heating control and/or humidity control of a space, which is associated with the visit reservation.

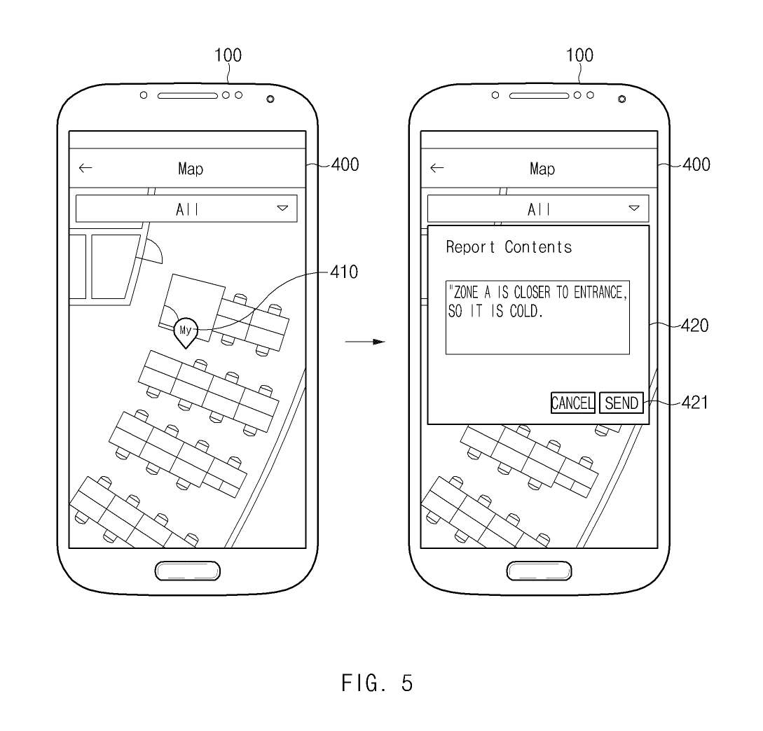

FIG. 5 is a view illustrating various forms of a third user interface output by the first electronic device, according to an embodiment.

According to an embodiment, a user of the first electronic device 100 may transmit request information associated with the management of the building to an external device (e.g., the third electronic device 800 of FIG. 1), which controls the automatic building control system described above, based on the execution of the first application. The request information may include, for example, information on a request for the control of at least one facility inside the building or information on a request for the maintenance of the facility In this connection, the processor 140 (see FIG. 2) of the first electronic device 100 may output the third user interface to support the input of the information on the request, when the first application is executed. Referring to FIG. 5, the processor 140 may be configured to display an initial screen of the third user interface 400, for example, at least a portion of space information (e.g., a map of the building) of the building.

In an embodiment, the processor 140 may track a user (or the first electronic device 100) positioned inside the building based on an indoor positioning system (IPS). The processor 140 may include a first object 410, which visually indicates the position of the user, in an area, which corresponds to the position of the tracked user, in a display area of the spatial information. When a user input (e.g., a touch) is applied to the first object 410, the processor 140 may output a second object 420, which allows the input of the request information, to overlap with at least a portion of the third user interface 400. In an embodiment, the second object 420 includes a third object 421 associated with the transmission of the input request information, and when a user input (e.g., a touch) is applied on the third object 421, the processor 140 may transmit the input request information to an external device (e.g., the third electronic device 800).

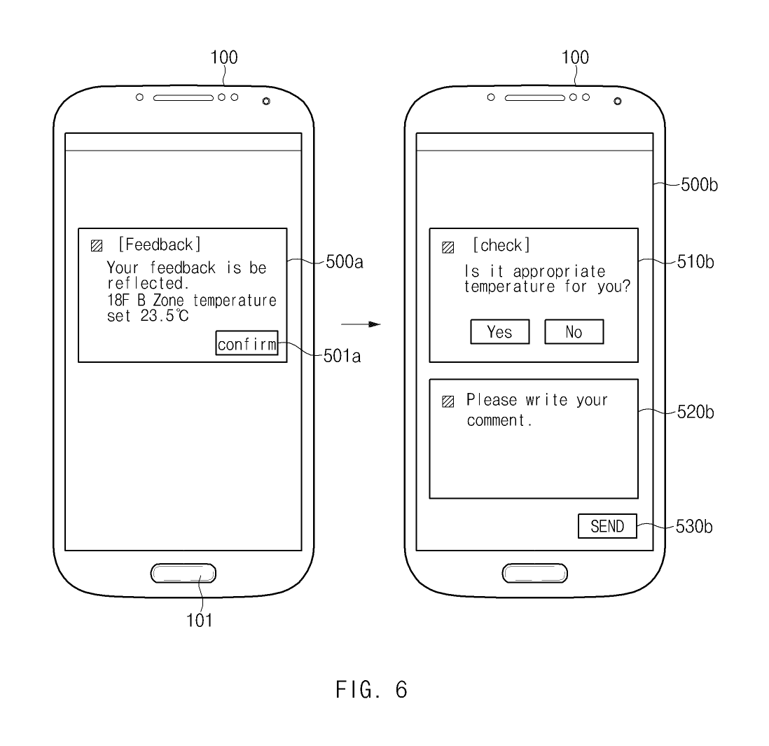

FIG. 6 is a view illustrating various forms of a fourth user interface output by the first electronic device, according to an embodiment.

According to an embodiment, as the first electronic device 100 transmits at least one information (e.g., feedback information, visit reservation information or request information) to the external device (e.g., the third electronic device 800 (FIG. 1)) which controls the automatic building control system, the first electronic device 100 may receive specified notification information from the external device (e.g., the third electronic device 800). For example, when changing or updating the schedule of the automatic building control system 1000 of FIG. 1, based on at least one of the feedback information or request information received from the first electronic device 100, the external device (e.g., the third electronic device 800) may transmit the information on the notification of the change or update to the first electronic device 100 positioned inside the building. Alternatively, when receiving the visit reservation information or updating the schedule based on the visit reservation information, the external device (e.g., the electronic device 800) may transmit the information on the notification of the reception or the update to the first electronic device 100 positioned outside the building.

Referring to FIG. 6, the processor (140 in FIG. 2) of the first electronic device 100 may output a message 500a including notification information on a specified screen (e.g., a screen off screen) of the first electronic device 100 in response to receiving the notification information. The message 500a may include information of the automatic building control system, which is updated by reflecting at least one of, for example, the feedback information, the visit reservation information, or the request information. According to an embodiment, the message 500a is temporarily disappeared when a specific time elapses from the output of the message 500a, and may be re-displayed when a user input (e.g., a touch) is applied to a home button area 101 of the first electronic device 100.

In an embodiment, the message 500a may include a first object 501a to support the execution of the first application described above. When a user input (e.g., touch) is applied to at least a portion of the first object 501a, the processor 140 may execute the first application and output a fourth user interface 500b. In an embodiment, the fourth user interface 500b may include a second object 510b including information on a question of asking a user about whether the user satisfies the change or the update of the schedule of the automatic building control system 1000 performed by the external device (e.g., the third electronic device 800), or a third object 530b associated with the transmission of information on the response of the user input onto the second object 510b. According to various embodiments, the fourth user interface 500b may further include a fourth object 520b for inputting the information on the comment of the user in association with the operation of the automatic building control system 1000. When a user input (e.g., a touch) is applied to at least a portion of the fourth object 520b, the processor 140 may output a software input panel (SIP) keyboard. The processor 140 may output a text to at least one area of the fourth object 520b in response to the user input onto the SIP keyboard. In addition, the processor 140 may transmit at least one of information on the answer to the question on the satisfaction of the user or comment information to an external device (e.g., the third device 800) based on a user input (e.g., touch) applied to the third object 530b.

According to an embodiment, an electronic device to interact with an external device operating an automatic building control system may include a communication module to make communication with the external device, a memory to store an application program associated with the automatic building control system, a display to output an execution screen of the application program, and a processor electrically connected with the communication module, the memory, and the display.

According to various embodiments, the processor may output at least one user interface to input specified information associated with updating a schedule of the automatic building control system or to input information on a response to a notification, which is transmitted from the external device, associated with the operation of the automatic building control system, when the application is executed.

According to various embodiments, the processor may transmit the information, which is input into the at least one user interface, to the external device.

According to various embodiments, the processor may output a first user interface to support input of feedback information of a user, which is associated with at least one of a temperature or humidity of a specific zone inside a building, when the application program is executed.

According to various embodiments, the processor may include, onto the first user interface, at least one of a first area to input information on a temperature desired by a user, a second area to input emotion information of the user, or a third area associated with transmitting the input information.

According to various embodiments, the processor may include, onto at least a portion of the first area, a first object to display a high or low of a temperature in color, in association with inputting the information on the temperature desired by the user.

According to various embodiments, the processor may include, into at least a portion of the second area, at least one second object serving as an index for an emotion degree, in association with inputting the emotion information of the user.

According to various embodiments, the processor may transmit at least one of the information on the temperature desired by the user or the emotion information of the user to the external device, when a specified user input is applied to at least a portion of the third area.

According to various embodiments, the processor may output the second user interface to support input of visit reservation information by the user for the building, when the application program is executed.

According to various embodiments, the processor may include, onto the second user interface, at least one of at least one first area to display visit reservation information input from another user, a second area associated with request for new visit reservation information, a third area to input the new visit reservation information, or a fourth area associated with transmitting input information.

According to various embodiments, the processor may transmit new visit reservation information of the user to the external device, when a specified user input is applied to at least a portion of the fourth area.

According to various embodiments, the processor may output a third user interface to support input of user request information associated with at least one of a control request for a facility inside a building or a request for maintenance of the facility, when the application program is executed.

According to various embodiments, the processor may display space information on the building on at least a portion of the third user interface, and include a first object, which is specified for an area, which corresponds to a user position in the building, of a display area of the space information.

According to various embodiments, the processor may output a second object for inputting the request information in overlap with at least a portion of the third user interface when a specified user input is applied to at least a portion of the first object.

According to various embodiments, the processor may include, into at least a portion of the second object, a third object associated with the transmission of the request information, and may transmit the request information to the external device when a specified user input is applied to at least a portion of the third object.

According to various embodiments, the processor may output a message associated with the notification transmitted from the external device.

According to various embodiments, the processor may output a fourth user interface including at least one of a first object including question information about the operation of the automatic building control system, a second object for inputting comment information of a user, or a third object associated with transmission of at least one of user answer information or comment information, when a specified user input is applied to at least a portion of the message.

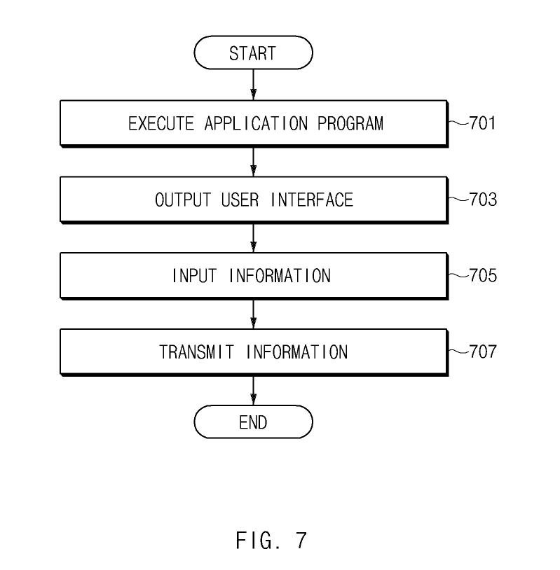

FIG. 7 is a view illustrating a method of providing information by the first electronic device, according to an embodiment.

Referring to FIG. 7, in operation 701, a user of a first electronic device (e.g., the first electronic device 100 of FIG. 1) may execute an application program systematically liked to an automatic building control system (e.g., the automatic building control system 1000 of FIG. 1). In this operation, the user may be positioned inside the building or positioned outside the building with the plan to visit the building.

In operation 703, a processor (e.g., the processor 140 of FIG. 2) of the first electronic device may output at least one user interface in response to the control of the user. For example, the processor may output, onto the execution screen of the application program, a specific user interface based on the manipulation of a specified menu by a user. According to an embodiment, at least one user interface may include at least one of a first user interface (e.g., the first user interface 200 of FIG. 3) to support the input of feedback information by a user based on specified building management, a second user interface (e.g., a second user interface 300a and/or 300b of FIG. 4) to support visit reservation information for a building, or a third interface (e.g., the third user interface 400 of FIG. 5) to support the input of information on the needs or the request of a user, which is associated with the management of the building. According to various embodiments, the at least one user interface may further include a fourth user interface (e.g., the fourth user interface 500b of FIG. 6) associated with notification information transmitted from a third electronic device (e.g., a control device of an automatic building control system, the third electronic device 800 of FIG. 1).

In operation 705, the user may input at least one piece of information on the provided user interface. In an embodiment, the user may input, onto the first user interface, information on a temperature desired by a user and/or user emotion information associated with a comfortable degree felt by the user as the user uses the building. In this operation, the user may set the desired temperature by applying a specified user input (e.g., a touch) to a first object (e.g., a color spectrum, the first object 211 of FIG. 3) included in a first user interface or may display a comfortable degree or an uncomfortable degree by applying a user input to any one of at least one second object (e.g., an emoticon, the second object 221 of FIG. 3).

In the case of the second user interface, the user may input at least one of user information (e.g., a profile image or name), information on a visit date (e.g., a date or time), information on the number of visitors, or space information (e.g., the room number of a guest room or a conference room) inside the building, in association with the request for the visit of the relevant building.

The user may input, onto the third user interface, various pieces of information such as request for the maintenance of a specific facility inside the building or the request for the control of a temperature or humidity. In this operation, the user may recognize the position of the user inside the building and detect the arrangement state of facilities in a surrounding area, based on at least a portion of space information (e.g., the map image for the building) included in the third user interface.

The first electronic device may receive specified notification information (e.g., the notification information of the change or the update of the schedule of an automatic building control system based on the reflection of user information) from the third electronic device and may output a message (e.g., the message 500a of FIG. 6) including the notification information. In this case, the user may input, onto the fourth user interface, information on the answer to the question about the satisfaction of the operation of the automatic building control system by the third electronic device.

In operation 707, the user may transmit at least one piece of information, which is input onto at least one user interface, to the third electronic device. For example, the user may perform information transmission by applying a user input (e.g., a touch) to a specific area or a specific object included in the user interface.

According to various embodiments, a method for providing information by an electronic device to interact with an external device operating an automatic building control system includes outputting at least one user interface to support input of specified information associated with updating a schedule of the automatic building control system or input of information on a response to a notification, which is transmitted from the external device, associated with the operation of the automatic building control system, when an application associated with the automatic building control system is executed and

According to various embodiments, the outputting of the user interface may include outputting a first user interface to support input of feedback information including at least one of information on a temperature desired by a user or emotion information of the user in association with at least one of request for temperature control or request for humidity control for a specific zone inside a building

According to various embodiments, the outputting of the user interface may include outputting a second user interface to support input of visit reservation information of a user for the building.

According to various embodiments, the outputting of the user interface may include outputting a third user interface to support input of user request information associated with at least one of a control request for a facility inside a building or a request for maintenance of the facility, when the application program is executed.

According to various embodiments, the method for providing information by the electronic device may further include receiving notification information transmitted from the external device in association with the operation of the automatic building control system.

According to various embodiments, the outputting of the user interface may include outputting a fourth user interface to support input of specified response information in association with receiving the notification information.

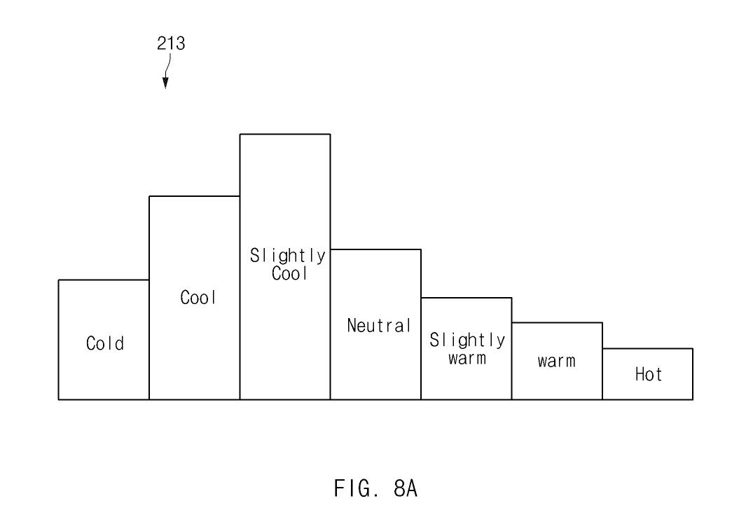

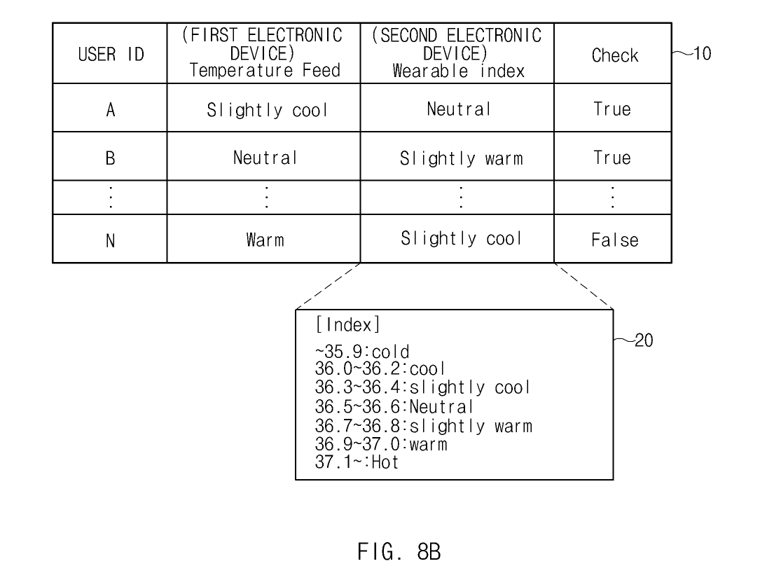

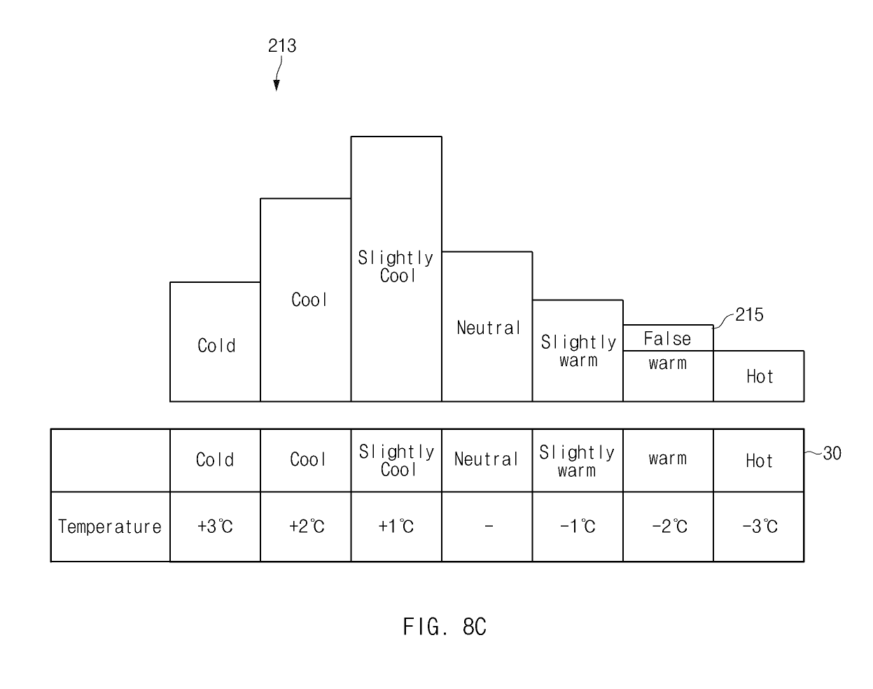

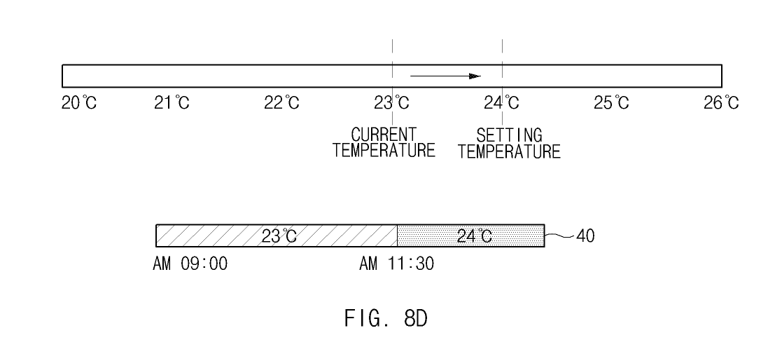

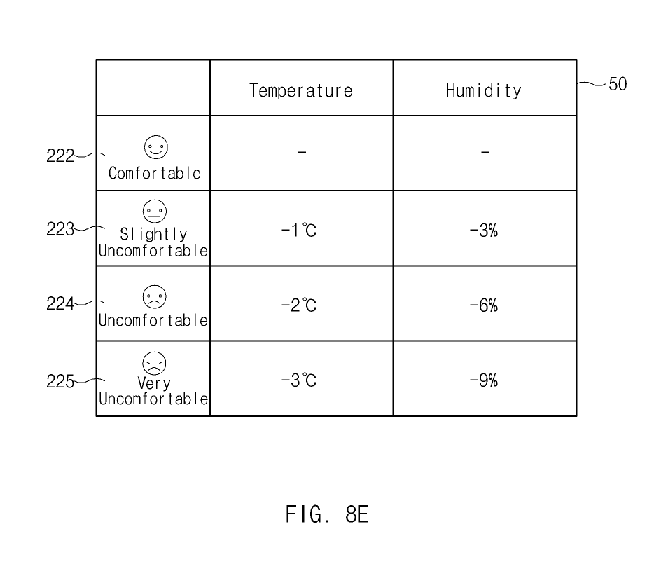

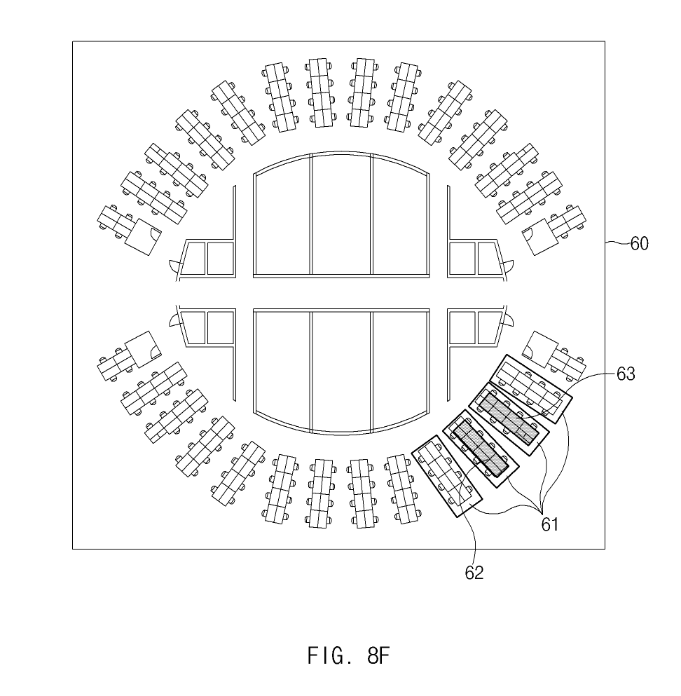

The following description will be made with reference to FIGS. 8A to 8G regarding various embodiments that a third electronic device (e.g., the control device of the automatic building control system, the third electronic device 800 of FIG. 1) changes or updates the schedule of an automatic building control system based on user feedback information provided by the above-described first electronic device (e.g., the first electronic device 100 of FIG. 1). In this connection, the third electronic device may include at least one component (e.g., a communication module, a memory, or a processor) the same as a component of the first electronic device or to perform a function corresponding to the component of the first electronic device. For example, the third electronic device may include a communication module to make communication with the first electronic device and/or the second electronic device (e.g., the second electronic device 600 of FIG. 1), a memory to store at least one piece of information received from the first electronic device and/or the second electronic device, or a processor to control the communication module and the memory.

FIG. 8A illustrates the collection form of information by the third electronic device, according to an embodiment, and FIG. 8B is a view illustrating the form of an information table formed by the third electronic device, according to an embodiment.

Referring to FIG. 8A, a processor of the third electronic device 800 may collect at least one piece of information on a temperature desired by a user, which is received from each of at least one first electronic device 100, in the form of a specified index (e.g., cold, cool, slightly cool, neutral, slightly warm, or warm) and may analyze at least one index 213 which is collected. According to an embodiment, the processor of the third electronic device 800 may consider body temperature information of the user, which is transmitted from the second electronic device 600, when analyzing the collected index 213. In this connection, the processor of the third electronic device may form a table 10 with indexes (e.g., cold, cool, slightly cool, neutral, slightly warm, warm, or hot) for the information on the temperature desired by the user and the body temperature information of the user which are received from each of the first electronic device 100 and the second electronic device 600, which are used by a first user (e.g., A), as illustrated in FIG. 8B. Similarly to or corresponding to this, the processor of the third electronic device 800 may form the table 10 for at least one information received from the first electronic device 100 and the second electronic device 600 which are used by an Nth user (e.g., N). In this case, the processor of the third electronic device 800 may convert the body temperature information of the user, which is received from the second electronic device 600, into the index based on a specified index 20 and reflect the converted index in the table 10.

According to an embodiment, the processor of the third electronic device 800 may determine the reliability for the information on the temperature desired by the user, which is received from the first electronic device 100, based on the formed table 10 and a specified index order (e.g., old-cool-slightly cool-neutral-slightly warm-warm-hot). For example, the processor of the third electronic device 800 may determine the information on the desired temperature by the user, which is transmitted from the first electronic device 100, as unclear information, when there are present a plurality of indexes between the index for the information on the temperature desired by the user and the index for the body temperature information by the body (or, when the index for the information on the temperature desired by the user and the index for the body temperature information of the user are spaced apart from each other in the specified index order).

FIG. 8C illustrates the collection form of second information by the third electronic device, according to an embodiment, and FIG. 8D is a view illustrating the temperature control of the third electronic device, according to an embodiment.

Referring to FIG. 8C, the processor of the third electronic device 800 may exclude at least one index (e.g., 215), which is determined as the unclear information, from the at least one index 213 which is received from each of the at least one first electronic device 100 and collected. The processor of the third electronic device 800 may extract an index (e.g., slightly cool), which is greater than a specified index value, from the at least one index 213 having no the index 215 which is unclear, and may determine a temperature control value (e.g., +1° C.), which corresponds to the extracted index (e.g., slightly cool) on an index 30 made in association with at least one index (e.g., cold, cool, slightly cool, neutral, slightly warm, warm, or hot)

According to an embodiment, the processor of the third electronic device 800 may reflect the determined temperature control value (+1° C.) with respect to a specific temperature set for a current cooling/heating control schedule of the automatic building control system 1000 (see FIG. 1). For example, as illustrated in FIG. 8D, the processor of the third electronic device 800 may update a cooling/heating control schedule 40 by reflecting the temperature control value (+1° C.) in the cooling/heating control schedule 40, which is preset to a specific temperature (e.g., about 23° C.)) The processor of the third electronic device 800 may manage the cooling/heating control schedule 40 based on the updated temperature (e.g., about 24° C.) in real time or after a specified time elapses based on a current time (e.g., 11:30 a.m.)

FIG. 8E is a view illustrating the form of index information formed in the third electronic device, according to an embodiment, and FIG. 8F is a view illustrating the control of a specific zone inside a building by the third electronic device, according to an embodiment.

Referring to FIG. 8E, the processor of the third electronic device 800 may form an index 50 for at least one object (e.g., the second object 221 of FIG. 3) serving as an index of user emotion information, in association with user emotion information received from the first electronic device 100. In one embodiment, the processor of the third electronic device 800 may set a temperature or humidity control value corresponding to at least one object (e.g., 223, 224, and/or 225), which serves as a negative index, of the at least one object 221, for the index 50. As described with reference to FIG. 3, the first electronic device 100 may transmit, to the third electronic device 800, both the user emotion information and the temperature desired by the user, which is described above. In this case, the processor of the third electronic device 800 may consider the temperature control value or the humidity control value set for the index 50 Meanwhile, when the first electronic device 100 transmits only the user emotion information, the processor of the third electronic device 800 may consider only the humidity control value of the index 50

According to an embodiment, when only the user emotion information is transmitted from the first electronic device 100, the processor of the third electronic device 800 may reflect a specific humidity control value of the index 50 in a specific zone inside a building. In this connection, referring to FIG. 8F, the processor of the third electronic device 800 may generate an object 60 including space information (e.g., a map image for the building) on the above-described building. In an embodiment, the processor of the third electronic device 800 may identify a zone 61 (hereinafter, referred to as a “first zone”), which corresponds to the position information of at least one first electronic device 100 obtained based on the IPS, from display areas corresponding to the space information (e.g., the map image for the building). In addition, the processor of the third electronic device 800 may obtain the position information of at least one first electronic device 100 which has transmitted the user emotion information through at least one object 223, 224, and/225 of FIG. 8E) serving as a negative index based on the IPS. The processor of the third electronic device 800 may further identify zones 62 and/or 63 (hereinafter, referred to as the second zone) corresponding to at least one first electronic device 100 having transmitted user emotion information through objects 223, 224, and/or 225 associated with the negative index, from the display areas corresponding to the space information (e.g., the map image for the building) included in the object 60.

In an embodiment, the processor of the third electronic device 800 may reflect a specific humidity control value included in the index 50 with respect to a specific zone, which corresponds to the second zone (62 and/or 63) on the object 60, of at least one zone inside the building. When user emotion information is transmitted based on the first negative index 223 (e.g., FIG. 8E) from the first electronic device 100 positioned in any one second zone (e.g., 62), the processor of the third electronic device 800 may control humidity for a zone, which corresponds to the second zone 62, inside the building by reflecting the humidity control value (e.g., −3%), which is set corresponding to the first negative index 223, in the index 50.

In an embodiment, when the user emotion information and the information on the temperature desired by the user are transmitted from the first electronic device 100, the processor of the third electronic device 800 may reflect a specified temperature control value and a specified humidity control value in a specific zone inside the building. For example, the processor 140 of the third electronic device 800 may operate the cooling/heat control (or the temperature control) for the zone, which corresponds to at least one first zone 61, inside the building by determining the temperature control value in a scheme the same as or similar to the scheme described with reference to FIGS. 8A to 8B and reflecting the determined temperature control value. In addition, the processor of the third electronic device 800 may perform humidity control for a zone, which corresponds to the at least one second zone 62 and/or 63, inside the building by determining and reflecting the relevant humidity control value on the index 50 based on a negative index based on user emotion information received from the first electronic device 100 positioned in the second zone 62 and/or 63.

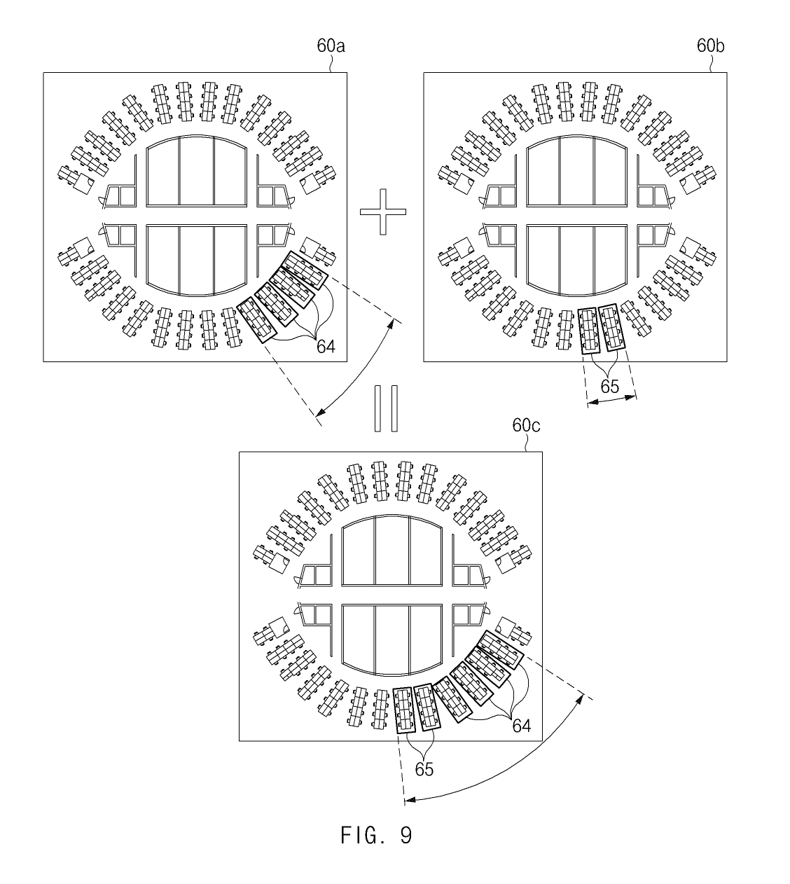

FIG. 9 is a view illustrating another example of the control for a specific zone inside the building by the third electronic device, according to an embodiment.

In an embodiment, the processor of a third electronic device (e.g., the third electronic device 800 of FIG. 1) may obtain position information of at least first electronic device 100 based on the IPS in association with the operation of the automatic building control system for the zone corresponding to the position of a user (or the position of a first electronic device (the first electronic device 100 of FIG. 1)) inside the building. The processor of the third electronic device 800 may generate a first object 60a including space information (e.g., the map image of the building) for the building and may include, on the first object 60a, identification information (hereinafter, referred to as “first identification information) indicating the position 64 of the first electronic device 100.

Thereafter, when the visit reservation information of the user is received from at least one first electronic device 100 which is positioned at the outside of the building, the processor of the third electronic device 800 may generate a second object 60b having the configuration the same as or corresponding to the configuration of the first object 60a. The processor of the third electronic device 800 may include, on the second object 60b, identification information (hereinafter, referred to as “second identification information) indicating at least one zone 65 corresponding to the visit reservation information (or a zone reserved for the visit by the user). In addition, the processor of the third electronic device 800 may include, as at least a portion of the second identification information, at least one of date information (e.g., a date or time) reserved for the least one zone 65 or information on the number of guests.

In an embodiment, the processor of the third electronic device 800 may generate a third object 60c based on the combination of the first object 60a and the second object 60b in association with the change and the update of the schedule of the automatic building control system 1000 (see FIG. 1) resulting from a new visit reservation. The third object 60c may include, for example, the first identification information and the second identification information. The processor of the third electronic device 800 may operate, based on the third object 60c created, the automatic building control system (e.g., heating/cooling control and/or humidity control) for a zone 64, in which the first electronic device 100 (or the user of the first electronic device 100) is positioned, and a zone 65, in which the first electronic device 100 (or the user of the new first electronic device 100) is to be positioned, resulting from the visit reservation, from at least one zone inside the building. For example, in the case of the zone 65 in which the new first electronic device 100 is positioned, the processor of the third electronic device 800 may control a temperature and/or humidity to an upper level or a lower level based on reserved occupancy time or the information on the reserved number of guests.

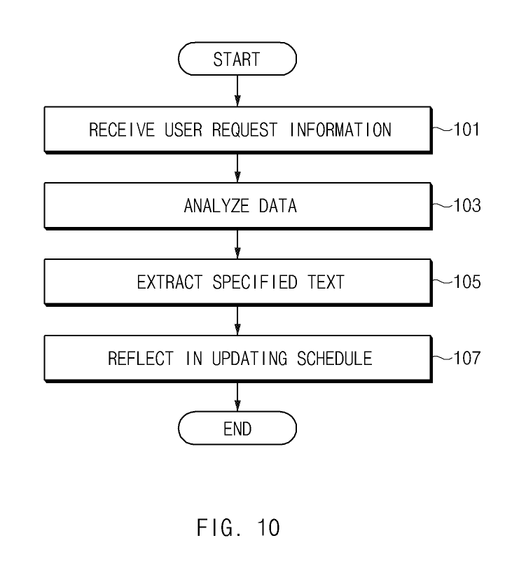

FIG. 10 is a flowchart illustrating the operation of the automatic building control system based on the request information of the third electronic device, according to an embodiment.

Referring to FIG. 10, in operation 101, the process of a third electronic device (e.g., a control device of an automatic building control system or the third electronic device 800 of FIG. 1) may receive user request information from the first electronic device (e.g., the mobile device of a building user or the first electronic device 100 of FIG. 1)

In operation 103 and operation 105, the processor of the third electronic device may extract specified keyword data by analyzing the received request information. In this connection, the processor of the third electronic device may specify at least one keyword associated with the operation of the automatic building control system (the automatic building control system 1000 of FIG. 1) and may construct a database. For example, the processor of the third electronic device may construct a database with keywords, which are associated with a temperature, humidity or building facilities, such as “temperature”, “heating,” “cooling,” “cold,” “it is cold,” “hot,” “ it is hot,” “entrance,” “humidity”, “it is wet” and/or “air conditioning”. The processor of the third electronic device may extract a keyword included in the request information by considering the database. Alternatively, according to various embodiments, the processor of the third electronic device may analyze health history information of the user received from the second electronic device (e.g., the wearable device of the building user or the second electronic device 600 of FIG. 1) Identically to or corresponding to the above description, the processor of the third electronic device may specify at least one keyword associated with the health, may construct a database, and may consider the keyword in analyzing the received health history information.

In operation 107, the processor of the third electronic device is trained (or cognized) with the user request information or the user health history information based on the extracted keyword, and reflects the trained information in the schedule update of the preset automatic control system. For example, the processor of the third electronic device may update the temperature or humidity control schedule for a zone (or the position zone of the first electronic device having transmitted the request information) associated with the transmitted information, in response to receiving the request information or the health history information. In various embodiments, the processor of the third electronic device may reflect the trained information in the notification information transmitted to the first electronic device. For example, when the request information includes failure information or repair request information of a specific facility, the processor of the third electronic device may transmit notification information, which is associated with the failure or repair processing of the specific facility, to the first electronic device.

According to various embodiments, the above-described building automatic control system may include a communication module to make communication with an external device, a memory to store information associated with the automatic building control system, and a processor electrically connected to the communication module and the memory.

According to various embodiments, the processor may be configured to schedule at least one of cooling/heating control and humidity control associated with the automatic building control and to change or update the schedule of the automatic building control system, based on at least one piece of information, which is received, when receiving at least one of visit reservation request information for the building, feedback information associated with to cooling/heating or humidity, and request information associated with the use of the building from the external device.

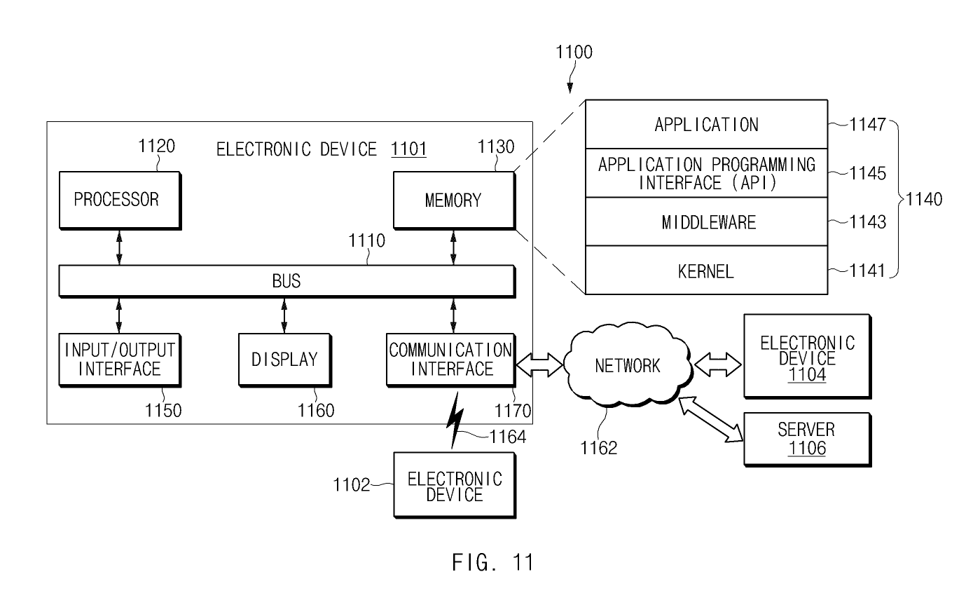

FIG. 11 is a diagram illustrating an electronic device in a network environment, according to an embodiment.

An electronic device 1101 in a network environment 1100 according to various embodiments of the present disclosure will be described with reference to FIG. 11. The electronic device 1101 may include a bus 1110, a processor 1120, a memory 1130, an input/output interface 1150, a display 1160, and a communication interface 1170. In various embodiments of the present disclosure, at least one of the foregoing elements may be omitted or another element may be added to the electronic device 1101.

The bus 1110 may include a circuit for connecting the above-mentioned elements 1110 to 1170 to each other and transferring communications (e.g., control messages and/or data) among the above-mentioned elements.

The processor 1120 may include at least one of a central processing unit (CPU), an application processor (AP), or a communication processor (CP). The processor 1120 may perform data processing or an operation related to communication and/or control of at least one of the other elements of the electronic device 1101.

The memory 1130 may include a volatile memory and/or a nonvolatile memory. The memory 1130 may store instructions or data related to at least one of the other elements of the electronic device 1101. According to an embodiment of the present disclosure, the memory 1130 may store software and/or a program 1140. The program 1140 may include, for example, a kernel 1141, a middleware 1143, an application programming interface (API) 1145, and/or an application program (or an application) 1147. At least a portion of the kernel 1141, the middleware 1143, or the API 1145 may be referred to as an operating system (OS).

The kernel 1141 may control or manage system resources (e.g., the bus 1110, the processor 1120, the memory 1130, or the like) used to perform operations or functions of other programs (e.g., the middleware 1143, the API 1145, or the application program 1147). Furthermore, the kernel 1141 may provide an interface for allowing the middleware 1143, the API 1145, or the application program 1147 to access individual elements of the electronic device 1101 in order to control or manage the system resources.

The middleware 1143 may serve as an intermediary so that the API 1145 or the application program 1147 communicates and exchanges data with the kernel 1141.

Furthermore, the middleware 1143 may handle one or more task requests received from the application program 1147 according to a priority order. For example, the middleware 1143 may assign at least one application program 1147 a priority for using the system resources (e.g., the bus 1110, the processor 1120, the memory 1130, or the like) of the electronic device 1101. For example, the middleware 1143 may handle the one or more task requests according to the priority assigned to the at least one application, thereby performing scheduling or load balancing with respect to the one or more task requests.

The API 1145, which is an interface for allowing the application 1147 to control a function provided by the kernel 1141 or the middleware 1143, may include, for example, at least one interface or function (e.g., instructions) for file control, window control, image processing, character control, or the like.

The input/output interface 1150 may serve to transfer an instruction or data input from a user or another external device to (an)other element(s) of the electronic device 1101. Furthermore, the input/output interface 1150 may output instructions or data received from (an)other element(s) of the electronic device 1101 to the user or another external device.

The display 1160 may include, for example, a liquid crystal display (LCD), a light-emitting diode (LED) display, an organic light-emitting diode (OLED) display, a microelectromechanical systems (MEMS) display, or an electronic paper display. The display 1160 may present various content (e.g., a text, an image, a video, an icon, a symbol, or the like) to the user. The display 1160 may include a touch screen, and may receive a touch, gesture, proximity or hovering input from an electronic pen or a part of a body of the user.

The communication interface 1170 may set communications between the electronic device 1101 and an external device (e.g., a first external electronic device 1102, a second external electronic device 1104, or a server 1106). For example, the communication interface 1170 may be connected to a network 1162 via wireless communications or wired communications so as to communicate with the external device (e.g., the second external electronic device 1104 or the server 1106).

The wireless communications may employ at least one of cellular communication protocols such as long-term evolution (LTE), LIE-advance (LTE-A), code division multiple access (CDMA), wideband CDMA (WCDMA), universal mobile telecommunications system (UMTS), wireless broadband (WiBro), or global system for mobile communications (GSM). The wireless communications may include, for example, a short-range communications 1164. The short-range communications may include at least one of wireless fidelity (Wi-Fi), Bluetooth, near field communication (NFC), magnetic stripe transmission (MST), or GNSS.

The MST may generate pulses according to transmission data and the pulses may generate electromagnetic signals. The electronic device 1101 may transmit the electromagnetic signals to a reader device such as a POS (point of sales) device. The POS device may detect the electromagnetic signals by using a MST reader and restore data by converting the detected electromagnetic signals into electrical signals.

The GNSS may include, for example, at least one of global positioning system (GPS), global navigation satellite system (GLONASS), BeiDou navigation satellite system (BeiDou), or Galileo, the European global satellite-based navigation system according to a use area or a bandwidth. Hereinafter, the term “GPS” and the term “GNSS” may be interchangeably used. The wired communications may include at least one of universal serial bus (USB), high definition multimedia interface (HDMI), recommended standard 232 (RS-232), plain old telephone service (POTS), or the like. The network 1162 may include at least one of telecommunications networks, for example, a computer network (e.g., local area network (LAN) or wide area network (WAN)), the Internet, or a telephone network.

The types of the first external electronic device 1102 and the second external electronic device 1104 may be the same as or different from the type of the electronic device 1101. According to an embodiment of the present disclosure, the server 1106 may include a group of one or more servers. A portion or all of operations performed in the electronic device 1101 may be performed in one or more other electronic devices (e.g., the first electronic device 1102, the second external electronic device 1104, or the server 1106). When the electronic device 1101 should perform a certain function or service automatically or in response to a request, the electronic device 1101 may request at least a portion of functions related to the function or service from another device (e.g., the first electronic device 1102, the second external electronic device 1104, or the server 1106) instead of or in addition to performing the function or service for itself. The other electronic device (e.g., the first electronic device 1102, the second external electronic device 1104, or the server 1106) may perform the requested function or additional function, and may transfer a result of the performance to the electronic device 1101. The electronic device 1101 may use a received result itself or additionally process the received result to provide the requested function or service. To this end, for example, a cloud computing technology, a distributed computing technology, or a client-server computing technology may be used.

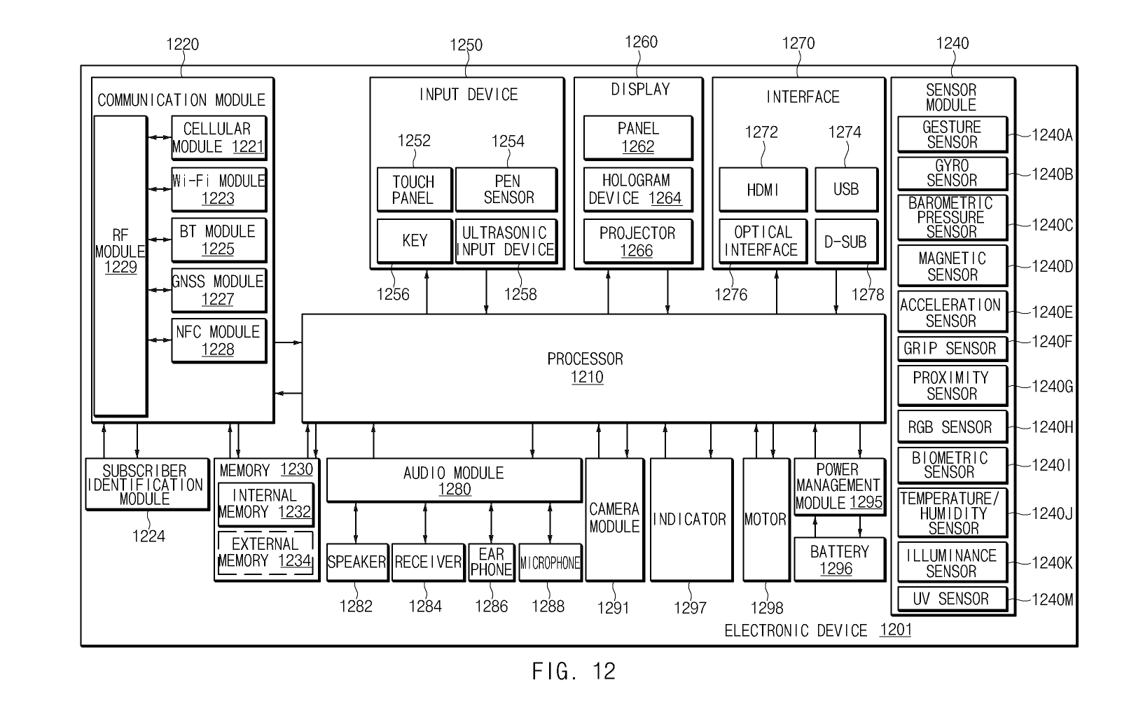

FIG. 12 is a block diagram of the electronic device, according to an embodiment.

Referring to FIG. 12, the electronic device 1201 may include, for example, all or part of an electronic device 1101 shown in FIG. 11. The electronic device 1201 may include one or more processors 1210 (e.g., application processors (APs)), a communication module 1220, a subscriber identification module (SIM) 1224, a memory 1230, a sensor module 1240, an input device 1250, a display 1260, an interface 1270, an audio module 1280, a camera module 1291, a power management module 1295, a battery 1296, an indicator 1297, and a motor 1298.

The processor 1210 may drive, for example, an operating system (OS) or an application program to control a plurality of hardware or software components connected thereto and may process and compute a variety of data. The processor 1210 may be implemented with, for example, a system on chip (SoC). According to an embodiment of the present disclosure, the processor 1210 may include a graphic processing unit (GPU) (not shown) and/or an image signal processor (not shown). The processor 1210 may include at least some (e.g., a cellular module 1221) of the components shown in FIG. 12. The processor 1210 may load a command or data received from at least one of other components (e.g., a non-volatile memory) into a volatile memory to process the data and may store various data in a non-volatile memory.

The communication module 1220 may have the same or similar configuration to the communication interface 1170 of FIG. 11. The communication module 1220 may include, for example, the cellular module 1221, a wireless-fidelity (Wi-Fi) module 1223, a Bluetooth (BT) module 1225, a global navigation satellite system (GNSS) module 1227 (e.g., a GPS module, a Glonass module, a Beidou module, or a Galileo module), a near field communication (NFC) module 1228, and a radio frequency (RF) module 1229.

The cellular module 1221 may provide, for example, a voice call service, a video call service, a text message service, or an Internet service, and the like through a communication network. According to an embodiment of the present disclosure, the cellular module 1221 may identify and authenticate the electronic device 1201 in a communication network using the SIM 1224 (e.g., a SIM card). According to an embodiment of the present disclosure, the cellular module 1221 may perform at least part of functions which may be provided by the processor 1210. According to an embodiment of the present disclosure, the cellular module 1221 may include a communication processor (CP).

The Wi-Fi module 1223, the BT module 1225, the GNSS module 1227, or the NFC module 1228 may include, for example, a processor for processing data transmitted and received through the corresponding module. According to various embodiments of the present disclosure, at least some (e.g., two or more) of the cellular module 1221, the Wi-Fi module 1223, the BT module 1225, the GNSS module 1227, or the NFC module 1228 may be included in one integrated chip (IC) or one IC package.

The RF module 1229 may transmit and receive, for example, a communication signal (e.g., an RF signal). Though not shown, the RF module 1229 may include, for example, a transceiver, a power amplifier module (PAM), a frequency filter, or a low noise amplifier (LNA), or an antenna, and the like. According to another embodiment of the present disclosure, at least one of the cellular module 1221, the Wi-Fi module 1223, the BT module 1225, the GNSS module 1227, or the NFC module 1228 may transmit and receive an RF signal through a separate RF module.

The SIM 1224 may include, for example, a card which includes a SIM and/or an embedded SIM. The SIM 1224 may include unique identification information (e.g., an integrated circuit card identifier (ICCID)) or subscriber information (e.g., an international mobile subscriber identity (IMSI)).

The memory 1230 (e.g., a memory 1130 of FIG. 11) may include, for example, an embedded memory 1232 or an external memory 1234. The embedded memory 1232 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 1234 may include a flash drive, for example, a compact flash (CF), a secure digital (SD), a micro-SD, a mini-SD, an extreme digital (xD), a multimedia card (MMC), or a memory stick, and the like. The external memory 1234 may operatively and/or physically connect with the electronic device 1201 through various interfaces.

The sensor module 1240 may measure, for example, a physical quantity or may detect an operation state of the electronic device 1201, and may convert the measured or detected information to an electric signal. The sensor module 1240 may include at least one of, for example, a gesture sensor 1240A, a gyro sensor 1240B, a barometric pressure sensor 1240C, a magnetic sensor 1240D, an acceleration sensor 1240E, a grip sensor 1240F, a proximity sensor 1240G, a color sensor 1240H (e.g., red, green, blue (RGB) sensor), a biometric sensor 1240I, a temperature/humidity sensor 1240J, an illumination sensor 1240K, or an ultraviolet (UV) sensor 1240M. Additionally or alternatively, the sensor module 1240 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 1240 may further include a control circuit for controlling at least one or more sensors included therein. According to various embodiments of the present disclosure, the electronic device 1201 may further include a processor configured to control the sensor module 1240, as part of the processor 1210 or to be independent of the processor 1210. While the processor 1210 is in a sleep state, the electronic device 1201 may control the sensor module 1240.

The input device 1250 may include, for example, a touch panel 1252, a (digital) pen sensor 1254, a key 1256, or an ultrasonic input device 1258. The touch panel 1252 may use at least one of, for example, a capacitive type, a resistive type, an infrared type, or an ultrasonic type. Also, the touch panel 1252 may further include a control circuit. The touch panel 1252 may further include a tactile layer and may provide a tactile reaction to a user.

The (digital) pen sensor 1254 may be, for example, part of the touch panel 1252 or may include a separate sheet for recognition. The key 1256 may include, for example, a physical button, an optical key, or a keypad. The ultrasonic input device 1258 may allow the electronic device 1201 to detect a sound wave using a microphone (e.g., a microphone 1288) and to verify data through an input tool generating an ultrasonic signal.

The display 1260 (e.g., a display 1160 of FIG. 11) may include a panel 1262, a hologram device 1264, or a projector 1266. The panel 1262 may include the same or similar configuration to the display 1160. The panel 1262 may be implemented to be, for example, flexible, transparent, or wearable. The panel 1262 and the touch panel 1252 may be integrated into one module. The hologram device 1264 may show a stereoscopic image in a space using interference of light. The projector 1266 may project light onto a screen to display an image. The screen may be positioned, for example, inside or outside the electronic device 1201. According to an embodiment of the present disclosure, the display 1260 may further include a control circuit for controlling the panel 1262, the hologram device 1264, or the projector 1266.

The interface 1270 may include, for example, a high-definition multimedia interface (HDMI) 1272, a universal serial bus (USB) 1274, an optical interface 1276, or a D-subminiature 1278. The interface 1270 may be included in, for example, the communication interface 1170 shown in FIG. 11. Additionally or alternatively, the interface 1270 may include, for example, a mobile high definition link (MHL) interface, an SD card/multimedia card (MMC) interface, or an infrared data association (IrDA) standard interface.

The audio module 1280 may convert a sound and an electric signal in dual directions. At least part of components of the audio module 1280 may be included in, for example, an input and output interface 1150 (or a user interface) shown in FIG. 11. The audio module 1280 may process sound information input or output through, for example, a speaker 1282, a receiver 1284, an earphone 1286, or the microphone 1288, and the like.

The camera module 1291 may be a device which captures a still image and a moving image. According to an embodiment of the present disclosure, the camera module 1291 may include one or more image sensors (not shown) (e.g., a front sensor or a rear sensor), a lens (not shown), an image signal processor (ISP) (not shown), or a flash (not shown) (e.g., an LED or a xenon lamp).

The power management module 1295 may manage, for example, power of the electronic device 1201. According to an embodiment of the present disclosure, though not shown, the power management module 1295 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 1296 and voltage, current, or temperature thereof while the battery 1296 is charged. The battery 1296 may include, for example, a rechargeable battery or a solar battery.

The indicator 1297 may display a specific state of the electronic device 1201 or part (e.g., the processor 1210) thereof, for example, a booting state, a message state, or a charging state, and the like. The motor 1298 may convert an electric signal into mechanical vibration and may generate vibration or a haptic effect, and the like. Though not shown, the electronic device 1201 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a MediaFLO™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

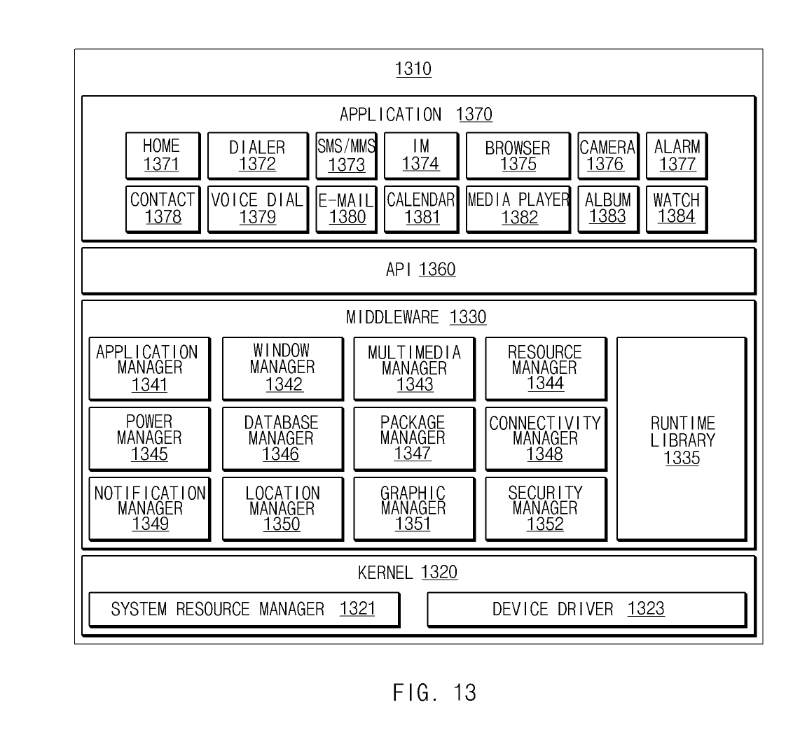

FIG. 13 is a block diagram of a program module, according to an embodiment.

According to an embodiment of the present disclosure, the program module 1310 (e.g., a program 1140 of FIG. 11) may include an operating system (OS) for controlling resources associated with an electronic device (e.g., an electronic device 1101 of FIG. 11) and/or various applications (e.g., an application program 1147 of FIG. 11) which are executed on the OS. The OS may be, for example, Android, iOS, Windows, Symbian, Tizen, or Bada, and the like.

The program module 1310 may include a kernel 1320, a middleware 1330, an application programming interface (API) 1360, and/or an application 1370. At least part of the program module 1310 may be preloaded on the electronic device, or may be downloaded from an external electronic device (e.g., a first external electronic device 1102, a second external electronic device 1104, or a server 1106, and the like of FIG. 11).

The kernel 1320 (e.g., a kernel 1141 of FIG. 11) may include, for example, a system resource manager 1321 and/or a device driver 1323. The system resource manager 1321 may control, assign, or collect, and the like system resources. According to an embodiment of the present disclosure, the system resource manager 1321 may include a process management unit, a memory management unit, or a file system management unit, and the like. The device driver 1323 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 1330 (e.g., a middleware 1143 of FIG. 11) may provide, for example, functions the application 1370 needs in common, and may provide various functions to the application 1370 through the API 1360 such that the application 1370 efficiently uses limited system resources in the electronic device. According to an embodiment of the present disclosure, the middleware 1330 (e.g., the middleware 1143) may include at least one of a runtime library 1335, an application manager 1341, a window manager 1342, a multimedia manager 1343, a resource manager 1344, a power manager 1345, a database manager 1346, a package manager 1347, a connectivity manager 1348, a notification manager 1349, a location manager 1350, a graphic manager 1351, or a security manager 1352.

The runtime library 1335 may include, for example, a library module used by a compiler to add a new function through a programming language while the application 1370 is executed. The runtime library 1335 may perform a function about input and output management, memory management, or an arithmetic function.

The application manager 1341 may manage, for example, a life cycle of at least one of the application 1370. The window manager 1342 may manage graphic user interface (GUI) resources used on a screen of the electronic device. The multimedia manager 1343 may determine a format utilized for reproducing various media files and may encode or decode a media file using a codec corresponding to the corresponding format. The resource manager 1344 may manage source codes of at least one of the application 1370, and may manage resources of a memory or a storage space, and the like.

The power manager 1345 may act together with, for example, a basic input/output system (BIOS) and the like, may manage a battery or a power source, and may provide power information utilized for an operation of the electronic device. The database manager 1346 may generate, search, or change a database to be used in at least one of the application 1370. The package manager 1347 may manage installation or update of an application distributed by a type of a package file.

The connectivity manager 1348 may manage, for example, wireless connection such as Wi-Fi connection or BT connection, and the like. The notification manager 1349 may display or notify events, such as an arrival message, an appointment, and proximity notification, by a method which is not disturbed to the user. The location manager 1350 may manage location information of the electronic device. The graphic manager 1351 may manage a graphic effect to be provided to the user or a user interface (UI) related to the graphic effect. The security manager 1352 may provide all security functions utilized for system security or user authentication, and the like. According to an embodiment of the present disclosure, when the electronic device (e.g., an electronic device 1101 of FIG. 11) has a phone function, the middleware 1330 may further include a telephony manager (not shown) for managing a voice or video communication function of the electronic device.

The middleware 1330 may include a middleware module which configures combinations of various functions of the above-described components. The middleware 1330 may provide a module which specializes according to kinds of OSs to provide a differentiated function. Also, the middleware 1330 may dynamically delete some of old components or may add new components.

The API 1360 (e.g., an API 1145 of FIG. 11) may be, for example, a set of API programming functions, and may be provided with different components according to OSs. For example, in case of Android or iOS, one API set may be provided according to platforms. In case of Tizen, two or more API sets may be provided according to platforms.

The application 1370 (e.g., an application program 1147 of FIG. 11) may include one or more of, for example, a home application 1371, a dialer application 1372, a short message service/multimedia message service (SMS/MMS) application 1373, an instant message (IM) application 1374, a browser application 1375, a camera application 1376, an alarm application 1377, a contact application 1378, a voice dial application 1379, an e-mail application 1380, a calendar application 1381, a media player application 1382, an album application 1383, a watch application 1384, a health care application (e.g., an application for measuring quantity of exercise or blood sugar, and the like), or an environment information application (e.g., an application for providing atmospheric pressure information, humidity information, or temperature information, and the like), and the like.

According to an embodiment of the present disclosure, the application 1370 may include an application (hereinafter, for better understanding and ease of description, referred to as “information exchange application”) for exchanging information between the electronic device (e.g., the electronic device 1101 of FIG. 11) and an external electronic device (e.g., the first external electronic device 1102 or the second external electronic device 1104). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 1102 or the second external electronic device 1104). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first external electronic device 1102 or the second external electronic device 1104) which communicates with the electronic device, an application which operates in the external electronic device, or a service (e.g., a call service or a message service) provided from the external electronic device.

According to an embodiment of the present disclosure, the application 1370 may include an application (e.g., the health care application of a mobile medical device) which is preset according to attributes of the external electronic device (e.g., the first external electronic device 1102 or the second external electronic device 1104). According to an embodiment of the present disclosure, the application 1370 may include an application received from the external electronic device (e.g., the server 1106, the first external electronic device 1102, or the second external electronic device 1104). According to an embodiment of the present disclosure, the application 1370 may include a preloaded application or a third party application which may be downloaded from a server. Names of the components of the program module 1310 according to various embodiments of the present disclosure may differ according to kinds of OSs.

According to various embodiments of the present disclosure, at least part of the program module 1310 may be implemented with software, firmware, hardware, or at least two or more combinations thereof. At least part of the program module 1310 may be implemented (e.g., executed) by, for example, a processor (e.g., a processor 1210). At least part of the program module 1310 may include, for example, a module, a program, a routine, sets of instructions, or a process, and the like for performing one or more functions.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor (e.g., the processor 1120), the processor may perform functions corresponding to the instructions. The computer-readable storage medium may be, for example, the memory 1130.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RANI, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

1. An electronic device to interact with an external device operating an automatic building control system, the electronic device comprising:
a communication module to make communication with the external device;
a memory to store an application program associated with the automatic building control system;
a display to output an execution screen of the application program; and
a processor electrically connected with the communication module, the memory, and the display,
wherein the processor is configured to:
output at least one user interface to input specified information associated with updating a schedule of the automatic building control system or to input information on a response to a notification, which is transmitted from the external device, associated with the operation of the automatic building control system, when the application is executed; and
transmit the information, which is input into the at least one user interface, to the external device.

2. The electronic device of claim 1, wherein the processor is configured to:
output a first user interface to support input of feedback information of a user, which is associated with at least one of a temperature or humidity of a specific zone in a building, when the application program is executed.

3. The electronic device of claim 2, wherein the processor is configured to:
include, onto the first user interface, at least one of a first area to input information on a temperature desired by a user, a second area to input emotion information of the user, or a third area associated with transmitting the input information.

4. The electronic device of claim 3, wherein the processor is configured to:
include, onto at least a portion of the first area, a first object to display a high or low of a temperature in color, in association with inputting the information on the temperature desired by the user.

5. The electronic device of claim 3, wherein the processor is configured to:
include, into at least a portion of the second area, at least one second object serving as an index for an emotion degree, in association with inputting the emotion information of the user.

6. The electronic device of claim 1, wherein the processor is configured to:
output a second user interface to support input of visit reservation information of a user for the building, when the application program is executed.

7. The electronic device of claim 6, wherein the processor is configured to: include, onto the second user interface, at least one of at least one first area to display visit reservation information input from another user, a second area associated with request for new visit reservation information, a third area to input the new visit reservation information, or a fourth area associated with transmitting input information.

8. The electronic device of claim 1, wherein the processor is configured to:
output a third user interface to support input of user request information associated with at least one of a control request for a facility inside a building or a request for maintenance of the facility, when the application program is executed.

9. The electronic device of claim 8, wherein the processor is configured to:
display space information on the building on at least a portion of the third user interface; and
include a first object, which is specified for a zone, which corresponds to a user position in the building, of a display area of the space information.

10. The electronic device of claim 9, wherein the processor is configured to:
output a second object for inputting the request information in overlap with at least a portion of the third user interface, when a specified user input is applied to at least a portion of the first object.

11. The electronic device of claim 1, wherein the processor is configured to:
output a message associated with the notification received from the external device; and
output a fourth user interface including at least one of a first object including question information about the operation of the automatic building control system, a second object for inputting comment information of a user, or a third object associated with transmission of at least one of user answer information or comment information, when a specified user input is applied to at least a portion of the message.

12. A method for providing information by an electronic device to interact with an external device operating an automatic building control system, the method comprising:
outputting at least one user interface to support input of specified information associated with updating a schedule of the automatic building control system or input of information on a response to a notification, which is transmitted from the external device, associated with the operation of the automatic building control system, when an application associated with the automatic building control system is executed; and
transmitting the information, which is input into the at least one user interface, to the external device.

13. The method of claim 12, wherein the outputting of the user interface includes:
outputting a first user interface to support input of feedback information including at least one of information on a temperature desired by a user or emotion information of the user, in association with at least one of request for temperature control or request for humidity control for a specific zone inside a building.

14.The method of claim 12, wherein the outputting of the user interface includes:
outputting a second user interface to support input of visit reservation information of a user for the building.

15. The method of claim 12, wherein the outputting of the user interface includes:
outputting a third user interface to support input of user request information associated with at least one of a control request for a facility inside a building or a request for maintenance of the facility.
